(19) United States
(12) Patent Application Publication
(10) Pub. No.: US 2021/0091558 A1
(43) Pub. Date: Mar. 25, 2021

(54) SECTIONALIZING SEQUENCE ORDER

(71) Applicant: S&C Electric Company, Chicago, IL (US)

(72) Inventors: Michael Meisinger, Chicago, IL (US); Martin Bishop, Oak Creek, WI (US); Stephen Williams, Caledonia, WI (US); David Porter, East Troy, WI (US)

(73) Assignee: S&C Electric Company, Chicago, IL (US)

(21) Appl. No.: 17/017,044

(22) Filed: Sep. 10, 2020

Related U.S. Application Data
(60) Provisional application No. 62/902,585, filed on Sep. 19, 2019.

(51) Int. Cl. H02H 7/22; H02H 3/08; H02H 3/38; H02H 3/02; H02H 3/06; H02H 3/00

(52) U.S. Cl. CPC H02H 7/22; H02H 3/08; H02H 3/003; H02H 3/021; H02H 3/06; H02H 3/38

(57) ABSTRACT

A control system and method for sectionalizing switches and a source interrupter/recloser in a feeder, or portion of the distribution grid, which enables fault location, isolation and service restoration without requiring a communications infrastructure and communications equipment at the switches. The method includes each switch adaptively configuring fault-count, load-count and voltage-count thresholds upon which the switch should open. The thresholds for each switch are based on the switch's proximity to the active feeder source, which requires a determination of which source is powering the feeder at a particular time. Five different methods are disclosed to determine which source is active. When a fault is detected, the source interrupter/recloser opens and then begins a pulse testing or reclosing sequence, where the switches open to isolate the fault when reaching their fault-count or voltage-count threshold. When the fault is isolated, the source recloses to restore power to unaffected portions of the feeder.

### BACKGROUND

### Field

The present disclosure relates generally to a control scheme for sectionalizing switches in an electrical grid feeder. More particularly, it relates to a system and method for controlling the behavior of sectionalizing switches in a feeder which enables proper fault isolation without requiring the switches to communicate with each other or a central controller.

### Discussion of the Related Art

An electrical power transmission and distribution network, often referred to as an electrical grid, typically includes a number of power generation plants each including a number of power generator units, such as gas turbine engines, nuclear reactors, coal-fired generators, hydro-electric dams, etc. The grid may also include wind and/or solar energy generation farms. Not only are there many different types of energy generators on the grid, but there are also many different types of loads, and the generators and loads are distributed over large geographic areas. The transmission grid carries electricity from the power plants over long distances at high voltages. The distribution grid, separated from the transmission grid by voltage-reducing substation transformers, provides electricity to the medium voltage feeder circuits that provide energy to distribution transformers at the points of utilization.

Many portions of the distribution grid, commonly known as feeders, are arranged between two or more different sources (i.e., substations), where one source is a main or primary source which is normally connected to and powers the feeder, and the other sources are alternates which are normally disconnected from the feeder by switches. Additional switches, known as sectionalizing switches, are also typically placed along the length of a feeder, thereby creating multiple feeder sections each separated by a switch, where each feeder section typically serves multiple customers. If a fault occurs in one of the feeder sections, the faulted feeder section can be isolated by opening one or more of the normally-closed sectionalizing switches.

Control of the sectionalizing switches has been largely automated in recent years, using a strategy known as fault location, isolation and service restoration (FLISR). FLISR applications can reduce the number of customers impacted by a fault by automatically isolating the trouble area and restoring service to healthy feeder sections by connecting them to adjacent circuits. In addition, the fault isolation feature of the technology can help crews locate the trouble spots more quickly, resulting in shorter outage durations for the customers impacted by the faulted section.

One known FLISR technique is centralized FLISR, where real-time communications between switches and a controller are required to locate and isolate a faulted section in a feeder. This type of centralized FLISR based on real-time communications is effective when the communication channels are operable but is completely defeated when communication is interrupted for any reason. The communication system also adds cost and complexity to the system that controls the switches. Another known FLISR technique involves pre-defined, static behavior characteristics for each sectionalizing switch. In this approach, each switch is pre-programmed to open if it experiences a certain number of fault current or voltage events, where the pre-programmed number is based on each switch's proximity to the feeder source. However, if the feeder source changes to an alternate, the pre-programmed sectionalizing switch behavior will result in incomplete or suboptimal fault isolation.

In view of the circumstances described above, there is a need for a methodology to control sectionalizing switches which does not rely on real-time communications between switches and controllers in distribution grid feeders, yet controls switch opening behavior properly to isolate faults.

### SUMMARY

The present disclosure describes a control system and method for sectionalizing switches and a source interrupter/recloser in a feeder, or portion of the distribution grid, which enables fault location, isolation and service restoration without requiring communications between the switches. The method includes each switch adaptively configuring fault-count, load-count and voltage-count thresholds upon which the switch should open. The thresholds for each switch are based on the switch's proximity to the active feeder source, which requires a determination of which source is powering the feeder at a particular time. Five different methods are disclosed to determine which source is active. When a fault is detected, the source opens and then begins a testing sequence, where the switches open to isolate the fault when reaching their fault-count threshold. When the fault is isolated, the source recloses to restore power to unaffected portions of the feeder.

Additional features of the present disclosure will become apparent from the following description and appended claims, taken in conjunction with the accompanying drawings.

### BRIEF DESCRIPTION OF THE DRAWINGS

FIG. 1 is a schematic diagram of a typical simple feeder, or portion of the distribution grid, as known in the art;

FIG. 2A is a schematic diagram of a feeder illustrating how known techniques for static pre-defined switch behavior logic effectively isolate a fault when the feeder source uses a conventional recloser device and the source is the one assumed in the pre-defined logic;

FIG. 2B is a schematic diagram of a feeder illustrating how known techniques for static pre-defined switch behavior logic fail to properly isolate a fault when the feeder source uses a conventional recloser device and the source is not the one assumed in the pre-defined logic;

FIG. 3A is a schematic diagram of a feeder illustrating a desired adaptive switch behavior logic which properly isolates a fault when a first source is powering the feeder through an interrupting/reclosing device, along with a first method used by sectionalizing switches for determining the active source, according to an embodiment of the present disclosure;

FIG. 3B is a schematic diagram of a feeder illustrating the desired adaptive switch behavior logic which properly isolates the fault when a second source is powering the feeder through an interrupting/reclosing device, along with the first method for determining the active source, according to an embodiment of the present disclosure;

FIG. 3C is a schematic diagram of a feeder illustrating the desired adaptive switch behavior logic which properly isolates the fault when a third source is powering the feeder through an interrupting/reclosing device, along with the first method for determining the active source, according to an embodiment of the present disclosure;

FIG. 4 is a graph of voltage and current traces on three phases provided by an interrupting/reclosing device that can test the circuit for faults using a low energy pulse, illustrating a second and third method used by sectionalizing switches for determining the active source, according to embodiments of the present disclosure;

FIG. 5 is a graph of voltage, current and power traces on a faulted phase provided by an interrupting/reclosing device that can test the circuit for faults using a low energy pulse, illustrating a fourth method used by sectionalizing switches for determining the active source, according to an embodiment of the present disclosure; and

FIG. 6 is a flowchart diagram of a method for defining sectionalizing switch behavior logic to properly isolate a fault based on a determined active feeder source which uses a conventional or pulse-testing interrupting/reclosing device, according to an embodiment of the present disclosure.

### DETAILED DESCRIPTION OF THE EMBODIMENTS

The following discussion of the embodiments of the disclosure directed to a technique for controlling the behavior of sectionalizing switches in a feeder for proper fault isolation without requiring a separate infrastructure to communicate with the switches is merely exemplary in nature and is in no way intended to limit the disclosure or its applications or uses.

An electrical power grid consists of a transmission network and a distribution network. The transmission network handles the movement of high-voltage electrical energy from a generating site, such as a power plant, to an electrical substation. The distribution network moves medium-voltage electrical energy on local wiring between substations and customers. Because the distribution portion of the grid includes power lines which are exposed to many hazards including wind, lightning, ice and snow, contamination, tree contacts, pole damage from vehicle collisions, etc., faults occur on the distribution grid. Fault location, isolation and service restoration (FLISR) is the name given to a set of techniques applied by many electric utilities to recover from faults on the distribution grid.

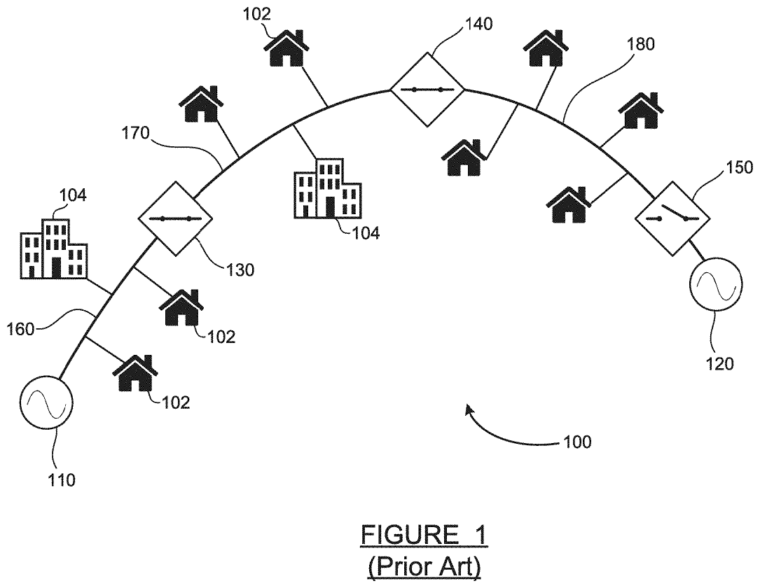

FIG. 1 is a schematic diagram of a typical feeder 100, or portion of the distribution grid, as known in the art. The feeder 100 provides electrical energy to many end customers, including houses 102 and businesses 104. The feeder 100 has a main source 110 at one end and an alternate source 120 at the other end. The sources 110 and 120 are typically substations that include a fault interrupting device at the connection of each feeder to the substation electrical bus (interrupting device and electrical bus not shown), where high voltage energy (often 60,000 volts line to line or greater) on the transmission grid is transformed down to medium voltage energy (often 38,000 volts line to line or less). The main source 110 is normally connected to and provides the power to the feeder 100, while the alternative source 120 is normally disconnected from the feeder 100 by a device such as a switch or a device that has fault interrupting/reclosing capability. While the following discussion focuses around three (3) phase feeder configuration, this discussion is meant to be exemplary and not limiting to other configurations, such as single phase configurations.

Between the main source 110 and the alternate source 120, switches 130, 140 and 150 divide the feeder 100 into sections. A section 160 is located between the main source 110 and the switch 130, a section 170 is located between the switch 130 and the switch 140, and a section 180 is located between the switch 140 and the switch 150. The switches 130 and 140 are normally closed, so that the main source 110 provides power to the sections 160, 170 and 180 of the feeder 100. The switch 150, which may be part of the source 120, is normally open, so that the alternative source 120 is normally not connected to the feeder 100. The switches 130 and 140, which separate the sections 160, 170 and 180, are known as sectionalizing switches.

It is to be understood that the feeder 100 is a three-phase circuit. That is, each of the sections 160, 170 and 180 includes three conductors (Phase A, Phase B and Phase C), each displaced electrically 120° from the others. The houses 102 and the businesses 104 may receive service from one or more of the phases, where the houses 102 almost always have single-phase service, and the businesses 104 may have three-phase service if they have high energy demands and/or large loads such as motors. The feeder 100 illustrated in FIG. 1 is very simple, not including branches as would be found in most actual implementations. The feeder 100 is merely shown and discussed here as a way of introducing general feeder terminology and describing the basic function of sectionalizing switches.

If a fault occurs in the feeder 100, such as for example a lightning strike which causes an insulation flashover of one or more power lines in the section 180 causing a line-to-line or line-to-ground fault, it is possible to isolate the fault and restore power to the sections 160 and 170 by opening the switch 140. This fault isolation and service restoration could be performed by line service crews visually locating the fault and manually opening the switch. A preferred alternative is the use of FLISR techniques, where fault isolation and service restoration happen automatically.

However, traditional centralized FLISR techniques require real-time communication between the switches 130, 140 and 150 and a common controller, so that voltage and current measurements at each device, along with device open/closed status, can be used to command and control the status of other adjacent devices. These real-time communication-based FLISR techniques work well as long as the communication channels are operable but are completely defeated if the communication channels are inoperable. Even with modern technology, any communication medium can experience an outage which may or may not be independent of the distribution feeder outage. In addition, the requirement for communications capability in the sectionalizing switches increases the cost and complexity of the switches. For these reasons, a new FLISR technique which does not require an additional real-time communication system infrastructure and can rely on sensor measurements made at each sectionalizing switch is needed.

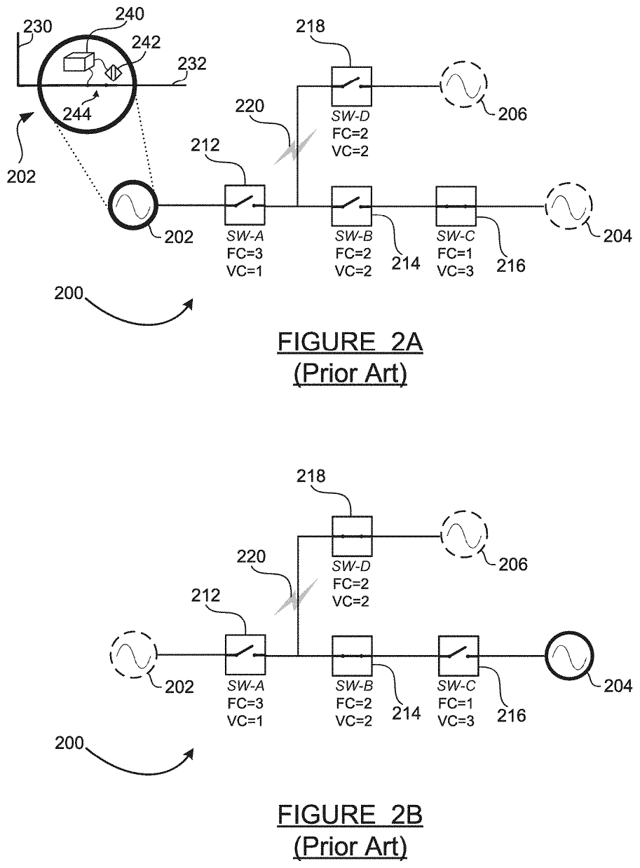

FIG. 2A is a schematic diagram of a feeder 200 illustrating how known techniques for static pre-defined switch behavior logic effectively isolate a fault when the feeder source is the one assumed in the pre-defined logic and the source includes a conventional fault interrupter/recloser to connect the feeder to the source. The feeder 200 includes a branch point and three different available sources, any one of which may be powering the feeder 200 at a particular time using a conventional fault interrupter/recloser. The feeder 200 also includes a plurality of sectionalizing switches, as discussed above. Loads are not shown in FIG. 2 for the sake of simplicity.

A source recloser 202 serves as an energy source for the feeder 200 and includes fault detection and circuit interrupting/reclosing capability which will be discussed further below. A block diagram of the main elements of the source recloser 202 is shown at the top left of FIG. 2A. The transmission grid provides high-voltage power to substation transformers that provide medium voltage on line 230 to the recloser 202 which provides the medium-voltage power to the feeder 200 on line 232. Again, both the lines 230 and 232 are three phases, represented here by a single line for simplicity. A controller 240 is in communication with a plurality of sensors 242 and fault interrupting/reclosing devices shown as switches 244. The controller 240 includes a processor and memory capable of storing data and programming instructions for controlling the operation of the source recloser 202. The sensors 242 include at least a current sensor and may include a voltage sensor on each of the three phases, where the sensors 242 are capable of detecting conditions such as low voltage or excess current which indicate a fault somewhere in the feeder 200 on one or more of the phases.

Based on data from the sensors 242, the controller 240 may determine that it is necessary to open the switches 244 for all three phases of power. Each of the switches 244 has one pole per phase of power, but normally all poles/phases are opened by the source recloser 202 when a fault is detected on any one or more of the phases, to completely de-energize the feeder 200. The controller 240 in the source recloser 202 also contains control logic for selectively reclosing the switches 244 in attempting to re-energize part of the feeder 200. For a sustained fault on the feeder 200, these reclosing attempts are performed at brief intervals after the fault-driven opening, after sufficient time has passed for the fault to be isolated by the sectionalizing switches. This sectionalizing switch and source recloser operation is discussed further below.

A source recloser 204 is located at the right end, on a lower branch of the feeder 200. A source recloser 206 is located at the right end, on an upper branch of the feeder 200. The source reclosers 204 and 206 are of the same design as the source recloser 202, having the sensors 242, the switches 244 and the controller 240. In the normal configuration of FIG. 2A, the source recloser 202 is active and providing power to the feeder 200, as indicated by its heavy, solid outline. The source reclosers 204 and 206 are connected to the feeder 200 in FIG. 2A, but in the normal configuration are open so they are not providing power to the circuit, as indicated by their thin, dashed outline.

The feeder 200 also includes a sectionalizing switch 212 (Switch A or “SW-A” for simplicity), a sectionalizing switch 214 (“SW-B”), a sectionalizing switch 216 (“SW-C”) and a sectionalizing switch 218 (“SW-D”). The sectionalizing switches 212-218 are all normally-closed, even though some are shown in an open condition in FIG. 2A (for reasons discussed below). In the known distributed FLISR technique of FIG. 2, the sectionalizing switches do not have the capability to use external communication infrastructure, but each of the sectionalizing switches 212-218 includes voltage sensors (on at least one phase) and current sensors (on all three phases) and a controller capable of opening the switch to isolate a fault. Switches typically open during the time that a source side interrupter is open since the switches may not have fault interrupting capability.

In the known distributed FLISR technique of FIG. 2, the controller in each of the sectionalizing switches 212-218 is configured with pre-defined static logic which determines under what conditions the switch will open. The pre-defined logic, designed to isolate a fault in the feeder 200 without opening more switches than necessary to isolate the fault, is based on each switch's proximity to the feeder source. The pre-defined logic is static, and in the case of the feeder 200, assumes that the source recloser 202 is the active source. The logic produces the desired result when the source recloser 202 is in fact the active source. However, as will be shown below, the static logic yields suboptimal results in situations where the source recloser 204 or the source recloser 206 becomes the active source for the feeder 200.

The sectionalizing switches 212-218 are each shown with a value for FC and a value for VC. FC represents fault counts, which is the number of fault current events that each switch must count during source reclosing attempts for the switch to trigger itself to open during a recloser open interval. VC represents voltage counts, which is the number of voltage detection (without fault current) events that each switch must count during source reclosing attempts for the switch to trigger itself to open during a recloser open interval. The pre-defined logic in the sectionalizing switches 212-218 dictates that switches nearest the source recloser have the lowest VC and the highest FC, while switches furthest from the source recloser have the highest VC and the lowest FC. For example, SW-A (212) is nearest the active source recloser 202, and therefore has values of FC=3 and VC=1. Conversely, SW-C (216) is furthest from the active source recloser 202, and therefore has values of FC=1 and VC=3.

Another event count threshold, load counts (LC), is also sometimes used in the sectionalizing switches 212-218. LC, or load count threshold, is the number of load current events that each switch must count during source reclosing attempts for the switch to trigger itself to open during a recloser open interval. Whereas fault currents are relatively high currents flowing through a switch from the source to a fault such as a short circuit, load currents are relatively lower currents flowing from the source to whatever loads are connected to the circuit downstream of a switch. Load counts may be used in place of voltage counts to enable opening of switches downstream of a fault without requiring voltage sensing capability in the switches. Though not shown on FIG. 2, the values for load count threshold (LC) are the same as the values for voltage count threshold (VC) at each switch.

The pre-defined values of FC, LC and VC are designed to cause the desired switch opening behavior in the event of a fault. For example, in the event of a fault 220 in the branch area between the sectionalizing switches 212, 214 and 218, the desired response is for the switches 212, 214 and 218 to open, thereby fully isolating the faulted feeder section. In this case, it is not desired for the switch 216 to open, because this is not needed to isolate the fault, and the switch 216 remaining closed offers the opportunity to restore service to feeder sections between the switches 214 and 216 from the source recloser 204.

The source reclosing and switch opening sequence proceeds as follows. On the first source reclosing attempt by the source recloser 202, the switch 212 senses a high fault current and therefore its counts become (FC=1; VC=0). The switches 214, 216 and 218 detect voltage but do not sense a fault current because they are not located between the source recloser and the fault; therefore, each of these switches have counts of (FC=0; VC=1), which does not cause any of them to open. On the second reclosing attempt by the source recloser 202, the switches 214, 216 and 218 again sense voltage but do not sense a fault current. Each of these switches have counts of (FC=0; VC=2), which causes the sectionalizing switches 214 and 218 to open. The switch 212 senses its second fault current event (FC=2) on the second reclosing attempt. On the third reclosing attempt, the switch 212 senses its third fault current event (FC=3), which causes it to open. On the third attempt, the switch 216 does not sense voltage because the switch 214 is open, so the switch 216 never reaches VC=3, and it remains closed. LC could be used in place of VC in the above discussion with the same effect.

In the manner discussed above, the known technique of using pre-defined fault and voltage counts for triggering sectionalizing switches to open based on a series of reclosing attempts works well when the source recloser is the one used to develop and program the fault and voltage counts into each switch control. However, as discussed below, the static logic yields suboptimal results when the source recloser for the feeder 200 changes.

FIG. 2B is a schematic diagram of the feeder 200 illustrating how known techniques for static pre-defined switch behavior logic based on fault counts and voltage counts fails to properly isolate a fault when the feeder source is not the one assumed in the development of the settings for the switches. The feeder 200 in FIG. 2B is the same as shown in FIG. 2A except that the source recloser 204 is now the active source. The source which provides power to a feeder can change from time to time for a variety of reasons, including one source (such as the source recloser 202) needing to be taken offline due to a problem or for preventive maintenance, or changes in load generation or consumption which cause the direction of power flow to change.

When the source recloser 204 is the active source for the feeder 200 and the fault 220 occurs, the reclosing attempt sequence is as follows. On the first reclosing attempt, the switch 212 senses a voltage but no fault current because it is not between the source and the fault. The switch 212 opens on VC=1, which is desirable to partially isolate the fault. Also, on the first reclosing attempt, the switch 216 senses a fault current because it is located between the source and the fault. The switch 216 opens on FC=1, which is suboptimal. Not only is it unnecessary to open the switch 216 to isolate the fault 220, it is also undesirable because the switch 216 being open prevents the switches 214 and 218 from sensing any more fault or voltage events, and these switches remain closed. FIG. 2B shows the final configuration of the feeder 200 after all reclosing attempts. This final configuration has both incomplete isolation and over-isolation. The switches 214 and 218 should be open, and the switch 216 should be closed so that feeder sections between the switches 214 and 216 can be re-energized.

The problems associated with statically defined switch behavior logic, described above, can be overcome by having the switch logic adapt to the active source of the feeder. This adaptive behavior can be achieved by the techniques of the present disclosure without requiring the cost and complexity of a communication system infrastructure and communication equipment within each of the switches, as discussed below.

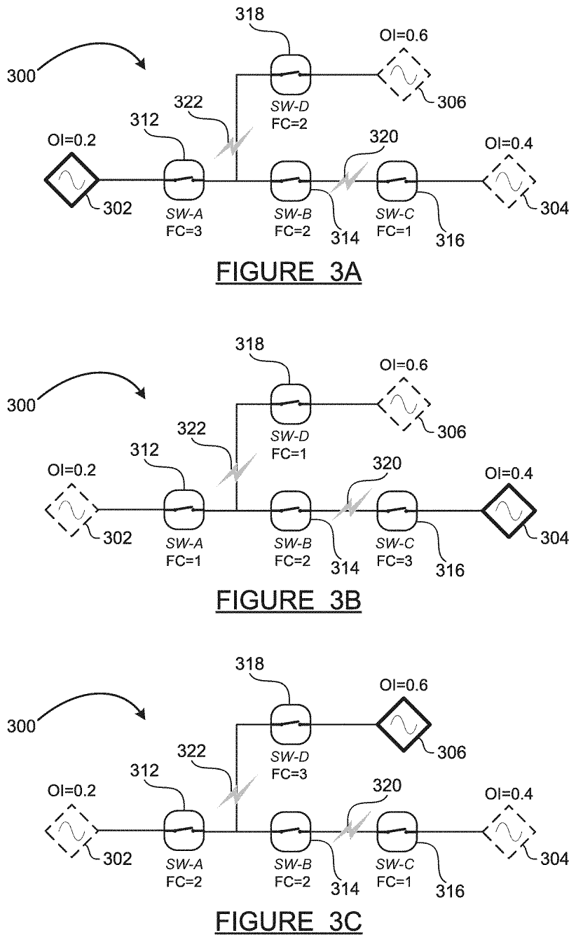

FIG. 3A is a schematic diagram of a feeder 300 illustrating a desired adaptive switch behavior logic which properly isolates a fault when a first source is powering the feeder, along with a first method used by sectionalizing switches for determining the active source, according to an embodiment of the present disclosure. The feeder 300 is identical in layout to the feeder 200 discussed above, having the same branched configuration with switches and sources in the same locations. However, the sectionalizing switches and the source reclosers in the feeder 300 are different devices having improved capability over those shown in the feeder 200. The fault interrupting/reclosing devices applied in this case may have pulse testing capability and can be configured in a way that allows the switches to determine the source being used to supply power to the circuit. The switches also have sufficient sensing capability to apply one of the adaptive configuration techniques described in the present disclosure.

The feeder 300 includes an interrupter/recloser 302 at the left end. The interrupter/recloser 302 provides power to the feeder 300 such as from a typical substation. It includes a controller, sensors and switches, and may have low energy pulse testing features which may be used in the improved sectionalizing switch behavior of the present disclosure. In FIG. 3A, the interrupter/recloser 302 is the active source to the feeder 300, as indicated by the heavy solid outline. Interrupter/reclosers 304 and 306, which are inactive in FIG. 3A, are positioned at the other ends of the feeder 300, where they may form a tie point connection to an adjacent feeder.

An interrupter/recloser such as the interrupter/recloser 302, as described in the present disclosure, is a device that includes fault interrupting and source reclosing capability, and in some embodiments includes the capability to perform low energy pulse testing of a circuit to determine if a fault continues to be present. The low energy pulse testing is used in place of full, high energy reclosing to test for the continued presence of a fault. The low energy pulse testing applies far less stress to transformers and other devices in a feeder in comparison to traditional high energy reclosing techniques. The use of pulse testing techniques by the interrupter/recloser 302 in the disclosed adaptive switch configuration, along with the use of traditional reclosing techniques, is discussed below.

The feeder 300 also includes a sectionalizing switch 312 (“SW-A”), a sectionalizing switch 314 (“SW-B”), a sectionalizing switch 316 (“SW-C”) and a sectionalizing switch 318 (“SW-D”). The sectionalizing switches 312-318 are all normally closed in the typical operation of the feeder 300 before any fault event. They are all shown in an intermediate condition (neither fully open nor fully close) in FIG. 3A, and their open/closed status is discussed below. The sectionalizing switches 312-318 are different devices than the sectionalizing switches 212-218 discussed previously. Each of the sectionalizing switches 312-318 includes current sensors and a controller capable of opening the switch to isolate a fault, but in most embodiments the switches 312-318 do not require voltage sensors. The sensors and controller logic in these switches must also be capable of recognizing the pulse test waveforms when the interrupter/recloser 302 is an interrupter/recloser with pulse testing capability. Further, the controller in each of the switches 312-318 is configured with the adaptive behavior logic of the present disclosure, including the ability to be configured with appropriate thresholds (for fault count, load count and/or voltage count) that are enabled when the switch determines the active source for the feeder section.

FIG. 3A (along with FIGS. 3B and 3C that follow) illustrates two key concepts of the present disclosure. The first concept is the adaptive logic employed by the sectionalizing switches 312-318 which redefines the fault count (FC) and optionally voltage count (VC) and/or load count (LC) threshold values for each switch based on the active source that supplies power to the feeder 300. The second concept is a method of determining which source is active based on local measurements at the switches. The method for determining active source shown in FIGS. 3A, 3B and 3C is one of five alternative methods for this determination. The other four methods are discussed later.

In the following discussion, two different faults—a fault 320 and a fault 322—are discussed. These faults do not occur simultaneously. They are provided to illustrate two completely different scenarios for fault location and adaptive switch sequencing. They further illustrate that the disclosed technique for sequence order adaptation properly handles both fault scenarios and any other fault location scenario.

The adaptive logic employed by the sectionalizing switches 312-318 is as follows. The fault count (FC) threshold for a switch nearest the active interrupter/recloser is set to a highest number of fault current events or fault test pulses (pulses recognized by the switch sensor and control as pulse waveforms expected when a fault is present). This fault count (FC) threshold is three in the case of the feeder 300 because no switch is more than three switch positions removed from any source. The fault count threshold for each other switch is set to a value one lower for each position the switch is further removed from the active interrupter/recloser. The switch furthest removed from the active interrupter/recloser has a fault count threshold of one. Voltage count (VC) and load count (LC) thresholds are defined in a reverse order to fault count; that is, VC and LC are set to one for the switch nearest the active source, and three for the switch furthest from the active source. The active interrupter/recloser then recloses (in the case of a traditional interrupter/recloser) or sends test pulses (in the case of a pulse-testing interrupter/recloser) until the maximum number is reached, thus giving each switch an opportunity to open if it reaches its threshold for fault count, voltage count or load count.

In the following discussion, the method of adaptive setting of fault count thresholds (FC, LC, VC) by the switches and the steps involved in the fault presence testing are discussed in terms of the low energy pulse testing technique. However, the method is equally applicable to the full reclosing technique for fault presence testing. In other words, when fault count (FC) thresholds are set to certain values for each switch, the events which are counted may be fault-pulse events or full fault-current events, depending on the capability of the interrupter/recloser. The same is true for load count (LC) and voltage count (VC) events.

In FIG. 3A, when the interrupter/recloser 302 is the active source, the switch 312 sets its fault count threshold to FC=3 (because it is closest to the active source), the switches 314 and 318 set their fault count threshold to FC=2 (because they are one switch position further from the active source), and the switch 316 (furthest from the active source) sets its fault count threshold to FC=1. The switches set the appropriate count through recognition of the proper source using one or more of the methods described in this disclosure. This logic works properly for any fault location in the feeder 300. For instance, if the fault 320 occurs between the switch 314 and the switch 316, when the interrupter/recloser 302 sends test pulses, only the switches 312 and 314 will sense a fault test pulse waveform pattern (because they are between the source and the fault). Therefore, the switch 314 which has a lower FC threshold will open on the second fault test pulse waveform (FC=2), which isolates the fault 320 from the source 302. When the interrupter/recloser 302 sends a third test pulse, it will sense that no fault is present in the portions of the feeder 300 to which it is still connected, and the interrupter/recloser 302 will therefore reclose to restore service to the remaining feeder sections other than those sections that have been disconnected from the source 302 through the opening of the switch 314. Voltage count (VC) and load count (LC) thresholds for each switch are set in the reverse order to FC threshold; for a switch with FC=3, VC=LC=1; and for a switch with FC=1, VC=LC=3.

The switch 316 will never sense fault test pulse waveforms from the interrupter/recloser 302 because the switch 316 is not between the source and the fault, so it will not open on fault count. However, after a predetermined interval, the interrupter/recloser 304 will determine that it is isolated from the interrupter/recloser 302 due to the loss of voltage (from the source 302 opening and also from the opening of the switch 314), and the interrupter/recloser 304 will begin its own test pulse sequence. When the interrupter/recloser 304 sends test pulses, the switch 316 will determine (by one of the methods discussed below) that the power source is now the interrupter/recloser 304, and the switch 316 will recognize that it is nearest the interrupter/recloser 304 and therefore must enable appropriate settings from pre-configured memory and set its threshold to FC=3. This logic is depicted in FIG. 3B. When the interrupter/recloser 304 sends its third test pulse, the switch 316 will open, thereby fully isolating the fault 320 on both sides.

In the case of the fault 322 located in the branch area between the switches 312, 314 and 318, the adaptive logic for setting fault count threshold still works properly. In this case, only the switch 312 will sense a fault pulse waveform from the source 302 because only the switch 312 is between the source 302 and the fault location for the fault 322. Thus, none of the switches 314-318 will sense a fault pulse waveform and therefore they will not accumulate fault counts and will not open. On the third test pulse by the interrupter/recloser 302, the switch 312 will sense a third fault pulse waveform, and will open on FC=3. This isolates the fault 322 from the interrupter/recloser 302.

After a pre-determined interval, the interrupter/reclosers 304 and 306 will both determine that they are isolated from the interrupter/recloser 302 (by the opening of the switch 312), and the interrupter/reclosers 304 and 306 will begin their own test pulse or reclosing sequences. The switches 316 and 318 will determine that they are now receiving power from a new source, enable the appropriate pre-configured threshold settings from memory, and set their threshold to FC=3 (because they are each the closest switch to their new source). The switch 314 will also determine that it is receiving power from a new source, enable the appropriate pre-configured settings from memory, and set its threshold to FC=2. The switch 314 will therefore open upon the second fault test pulse waveform from the interrupter/recloser 304 (FC=2), and the switch 316 will remain closed as desired. The switch 318 will open upon the third fault test pulse waveform from the interrupter/recloser 306 (FC=3). With the switches 318, 314 and 312 all open, the fault 322 is now fully isolated.

It is also possible that, after a single sectionalizing switch opens, a fault will be fully isolated. This would be the case if a fault were located, for example, between the interrupter/recloser 304 and the switch 316, with the interrupter/recloser 302 active, in FIG. 3A. In this case, the switch 316 would open on the first fault test pulse waveform (FC=1), and the fault would be fully isolated. The interrupter/recloser 302 would determine that the fault is no longer present because the second test pulse or reclosing would not result in a fault test pulse waveform or a fault current. The interrupter/recloser 302 would then reclose, restoring power to the remainder of the feeder 300. After a pre-determined time, the interrupter/recloser 304 (based on a loss of voltage) would pulse test one or more times, detect the fault, and remain open.

As mentioned before, the low energy test pulses described above are different from a traditional full reclosing attempt. The test pulses performed by the interrupter/reclosers 302/304/306 are short-duration, low energy test pulses sent by the interrupter/recloser which allow the sectionalizing switches to determine status without experiencing a high energy fault current. The low energy test pulses are designed with timing characteristics which are known to the sectionalizing switches and which enable the sectionalizing switches to determine source direction in a variety of ways, discussed below. Although low-energy pulse testing is desirable, the adaptive fault count threshold logic is also applicable to full reclosing fault count events.

It is emphasized here that, with a priori knowledge of the feeder topology, the disclosed adaptive sectionalizing sequence order may be implemented without an additional communications system infrastructure to separately send messages to the switches, and without the need to add voltage sensing hardware at the switches. Other source scenarios are discussed below for completeness.

FIG. 3B is a schematic diagram of the feeder 300 illustrating the desired adaptive switch behavior logic which properly isolates the fault when a second source is powering the feeder, along with the first method for determining the active source, according to an embodiment of the present disclosure. In FIG. 3B, the interrupter/recloser 304 is initially the active source to the feeder 300. Therefore, the switch 316 (which is nearest the active source) has a threshold of FC=3. The switch 314 (one switch position further removed from the active source) has a threshold of FC=2. The switches 312 and 318 have a threshold of FC=1.

When the fault 320 occurs in FIG. 3B, the interrupter/recloser 304 begins its test pulse or reclosing sequence. Only the switch 316 will sense a fault pulse waveform or fault current, so the switch 316 will open on FC=3. At that point, after a preset time delay, both the interrupter/reclosers 302 and 306 will determine that they are isolated from the previous source 304. Either the interrupter/recloser 302 or the interrupter/recloser 306 (based on predetermined hierarchy) can then begin its test pulse sequence or reclosing sequence. If the interrupter/recloser 306 takes precedence, then the sectionalizing switches 312, 314 and 318 will set their thresholds from pre-configured memory as shown in FIG. 3C. If the interrupter/recloser 302 takes precedence, then the sectionalizing switches 312, 314 and 318 will set their thresholds from memory as shown in FIG. 3A. Either way, the switch 314 will sense two fault pulse waveforms and open upon FC=2, which will fully isolate the fault 320. The interrupter/recloser 302 or 306 which took precedence and ran its test sequence will reclose, which restores power to the remaining sections of the feeder except the section bounded by the switch 314 and the switch 316, where the fault 320 is located.

When the fault 322 occurs in FIG. 3B, the interrupter/recloser 304 begins its test pulse sequence. Only the switches 314 and 316 will sense fault pulse waveforms, and the switch 314 will open after sensing the second fault pulse waveform on FC=2. The interrupter/recloser 304 then recloses to restore power to customers between the source 304 and the switch 314. At that point, after the preset time delay, both the interrupter/reclosers 302 and 306 will determine that they are isolated from the previous source 304. Either the interrupter/recloser 302 or the interrupter/recloser 306 (based on the predetermined precedence hierarchy) can then begin a test pulse sequence. If the interrupter/recloser 306 takes precedence, then only the switch 318 will sense a fault pulse waveform, and the switch 318 will open after sensing three fault pulse waveforms on FC=3. The interrupter/recloser 302 will then determine that it is isolated from the other sources and (after another time delay since loss of voltage) begin its test sequence, which will result in the switch 312 sensing three fault pulse waveforms and opening on FC=3. At that point, with the switches 314, 318 and 312 all open, the fault 322 will be fully isolated. The process also works to properly isolate the fault 322 if the interrupter/recloser 302 takes precedence over the interrupter/recloser 306 in the above scenario.

FIG. 3C is a schematic diagram of the feeder 300 illustrating the desired adaptive switch behavior logic which properly isolates the fault when a third source is powering the feeder, along with the first method for determining the active source, according to an embodiment of the present disclosure. In FIG. 3C, the interrupter/recloser 306 is initially the active source to the feeder 300. Therefore, the switch 318 (which is nearest the active source) has a threshold of FC=3. The switches 314 and 312 (one switch position further removed from the active source) have thresholds of FC=2. The switch 316 has a threshold of FC=1.

When the fault 320 occurs in FIG. 3C, the interrupter/recloser 306 begins its test pulse sequence (or full reclosing sequence if not pulse-test capable). Only the switches 318 and 314 will sense a fault pulse waveform, so the switch 314 senses two fault pulses and will open on FC=2. The interrupter/recloser 306 then recloses to restore power to customers connected to the left of the switch 314 and in the upper branch. At that point, after a preset time delay, the interrupter/recloser 304 will determine from loss of voltage that it is isolated from the previous source 306 (because the switch 314 is open). The interrupter/recloser 304 can then begin its test pulse sequence. Only the switch 316 will sense a fault pulse waveform from the interrupter/recloser 304 with the location of the fault 320, and therefore the switch 316 will recognize that a new source is powering the circuit, changes to the pre-configured count settings, and after sensing three fault pulse waveforms, opens upon FC=3, which will fully isolate the fault 320.

When the fault 322 occurs in FIG. 3C, the interrupter/recloser 306 begins its test pulse sequence. Only the switch 318 will sense a fault pulse waveform, and the switch 318 will sense three fault pulses and open on FC=3. The interrupter/recloser 306 then recloses to restore power to customers connected between the source 306 and the switch 318. At that point, after the preset time delay, both the interrupter/reclosers 302 and 304 will determine from loss of voltage that they are isolated from the previous source 306. Either the interrupter/recloser 302 or the interrupter/recloser 304 (based on the predetermined precedence hierarchy) can then begin its test pulse sequence. If the interrupter/recloser 302 takes precedence, then only the switch 312 will sense a fault pulse waveform from the source 302, and the switch 312 will recognize the alternative source of power and change settings after recognizing that the new source is active, and will open on FC=3. The interrupter/recloser 304 will then determine that it is isolated from the other sources and (after the time delay) begin its test sequence, which will result in the switches 314 and 316 sensing a new source is active, changing settings according to the preconfigured settings information and then switch 314 opening on FC=2. At that point, with the switches 314, 318 and 312 all open, the fault 322 will be fully isolated. The interrupter/reclosers 302 and 304 will reclose after their test pulse sequence results in no fault pulse after three sectionalizing switches open to fully isolate the fault. The process also works to properly isolate the fault 322 if the interrupter/recloser 304 takes precedence over the interrupter/recloser 302 in the above scenario.

The discussion of FIGS. 3A, 3B and 3C above has illustrated that the adaptive sectionalizing switch sequencing order of the present disclosure is effective at isolating a fault at any location in a distribution grid feeder. For the adaptive switch opening (FC) logic described above to be implemented, the switches must recognize the topology of the feeder 300 from pre-configured information (locations and connectivity of the interrupter/reclosers and the sectionalizing switches), the switches must have current measuring sensors, and they must have control logic that is able to recognize which source is active. Based on this information, the controller in each of the sectionalizing switches can properly set the FC threshold value. Again, the FC threshold can be applied to pulse-testing (fault pulse) events as in the preceding discussion, or to full fault current events experienced during a conventional reclosing sequence.

In the preceding detailed discussion, switch fault count (FC) thresholds were adaptively configured based on the identity of the active source. It is likewise possible to adaptively configure load count (LC) and/or voltage count (VC) thresholds based on the active source. As discussed earlier, a switch with a high FC threshold (e.g., FC=3) will have a low LC or VC threshold (1), and vice versa. Several techniques for determining the active source are disclosed in the discussion that follows. Any of these techniques, or a combination of the techniques, may be used for a particular feeder application.

One technique for determining the active source is disclosed in FIGS. 3A, 3B and 3C. This first method for determining the active source is based on the detection of a first open interval (OI) time after a fault is detected in the feeder 300. In this technique, each of the interrupter/reclosers 302, 304 and 306 is pre-configured with a unique OI time value. As shown in FIGS. 3A, 3B and 3C, the interrupter/recloser 302 has an OI of 0.2 seconds, the interrupter/recloser 304 has an OI of 0.4 seconds, and the interrupter/recloser 306 has an OI of 0.6 seconds.

During operation of the feeder 300, each of the interrupter/reclosers know whether they are active or not, based on the status of their internal switches (equivalent to the switches 244 in the source recloser 202 of FIG. 2) and information from their voltage and current sensors (the sensors 242). When a fault occurs in the feeder 300, only the interrupter/recloser which is actively supplying energy to the feeder will detect the fault and open and then respond with a reclosing or pulse-test sequence. If the interrupter/recloser 302 is active when a fault occurs (as in FIG. 3A), the interrupter/recloser 302 will immediately open its internal switches to cut off power to the feeder 300, then it will wait for its pre-configured open interval of 0.2 seconds before beginning its test pulse sequence or reclosing sequence as discussed above. Each of the sectionalizing switches in the feeder 300 will recognize the open interval of 0.2 seconds (the elapsed time between power cutoff and the first test pulse) as meaning that the interrupter/recloser 302 is the active source, and each switch will configure its fault count (FC) threshold accordingly, using the preconfigured settings information described above.

The pre-configured OI time values are known to all of the interrupter/reclosers and all of the sectionalizing switches in the feeder 300; this is part of the a priori knowledge (along with feeder topology) which is provided to all devices in the feeder when the feeder is configured. If the interrupter/recloser 304 is active when a fault occurs, it will immediately cut off power to the feeder 300, then wait for its OI=0.4 seconds before beginning its test pulse or reclosing sequence, and the sectionalizing switches will recognize and adapt to the active source 304 based on the open interval. If the interrupter/recloser 306 is active when a fault occurs, it will immediately cut off power to the feeder 300, then wait for its OI=0.6 seconds before beginning its test pulse or reclosing sequence, and the sectionalizing switches will recognize and adapt to the active source 306 based on the open interval.

The pre-configured OI time values can also be applied to subsequent test pulses to allow the switches to identify which alternate interrupter/recloser 302, 304, or 306 is testing after the switch section has been isolated from its initially active source.

The Open Interval (OI) time values are applicable to full reclosing techniques, in addition to the pulse-closing technique discussed above. In systems where the interrupter/reclosers use full reclosing to determine the continued presence of a fault, the OI time value represents the time between the fault interruption and when the interrupter/recloser begins its reclosing sequence. Each interrupter/recloser is pre-assigned a unique value of OI, as discussed earlier.

Other techniques for determining the active source are also disclosed herein. Regardless of the method used to determine the active source, the switch opening (FC/LC/VC threshold) logic of FIGS. 3A, 3B and 3C is employed by the sectionalizing switches 312-318 in the feeder 300.

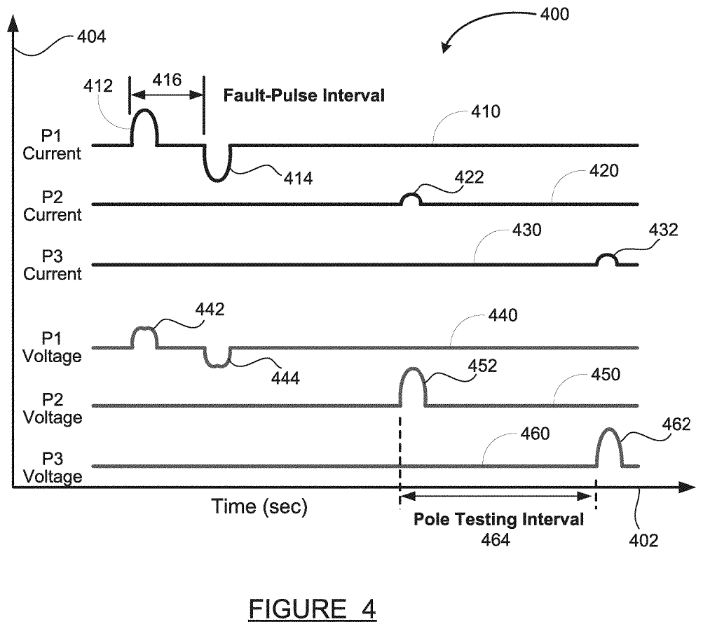

FIG. 4 is a graph 400 of voltage and current traces on three phases provided by an interrupter/recloser with pulse testing capability, illustrating a second and third method used by sectionalizing switches for determining the active source, according to embodiments of the present disclosure. A horizontal axis 402 represents time in seconds, and a vertical axis 404 represents current for current traces and voltage for voltage traces. For the purposes of understanding FIG. 4, the feeder 300 of FIG. 3 may be considered, although the techniques work properly for any feeder configuration. In the scenario shown in FIG. 4, a fault has been detected in phase #1 of the feeder (which equates to pole #1, or P1, of the switches in the interrupter/reclosers).

A trace 410 shows the current provided by the active interrupter/recloser on the faulted pole P1, a trace 420 shows the current provided by the active interrupter/recloser on non-faulted pole P2, and a trace 430 shows the current provided by the active interrupter/recloser on non-faulted pole P3. Similarly, a trace 440 shows the voltage provided by the active interrupter/recloser on the faulted pole P1, a trace 450 shows the voltage provided by the active interrupter/recloser on non-faulted pole P2, and a trace 460 shows the voltage provided by the active interrupter/recloser on non-faulted pole P3. All of the traces 410, 420, 430, 440, 450 and 460 are associated with a pulse-testing sequence by the interrupter/recloser.

It was mentioned earlier that the pulse-testing capable interrupter/reclosers of the present disclosure do not perform a full reclosing operation, with the resultant high energy current flowing on the faulted phase, when attempting to isolate a fault. Rather, the interrupter/reclosers provide a low energy test pulse which is sufficient to detect feeder behavior and fault presence, but which is intentionally much lower in energy delivered to prevent additional system stress. This low energy characteristic is visible in pulses 442 (initial) and 444 (inverse) on the voltage trace 440. By controlling the maximum voltage and the duration of the pulses 442 and 444, the resultant current pulses 412 and 414 on the faulted pole P1 are lower in delivered energy but are still recognizable as pulses that would be generated when a fault is present. These are the fault pulse waveforms detected by the sectionalizing switches and compared to their fault count (FC) threshold as discussed relative to FIG. 3.

One method (the second disclosed method) for determining the active source to the feeder is to configure each of the interrupter/reclosers to use a different fault-pulse time interval 416. The fault-pulse time interval 416 is the amount of time between the beginning of the initial voltage pulse 442 and the beginning of the inverse voltage pulse 444, which is detected in each of the sectionalizing switches as the time between an initial and inverse current pulse. It is noted that the sectionalizing switches will detect initial and inverse current pulses on the faulted pole even if they are not between the source and the fault. The initial and inverse current pulses will only be large magnitude fault current pulses if the particular sectionalizing switch is between the source and the fault. Otherwise, the current pulses detected by the sectionalizing switches will be much smaller, based on loads in the feeder sections downstream of the switch.

The fault-pulse interval 416 may be pre-configured to have a known and different value for each of the interrupter/reclosers. For example, the interrupter/recloser 302 in the feeder 300 may have the fault-pulse interval 416 defined as 0.1 seconds, the interrupter/recloser 304 in the feeder 300 may have the fault-pulse interval 416 defined as 0.2 seconds, and the interrupter/recloser 306 in the feeder 300 may have the fault-pulse interval 416 defined as 0.3 seconds. The sectionalizing switches in the feeder 300 can then determine which of the interrupter/reclosers is the active source based on the fault-pulse interval 416, and the sectionalizing switches then adaptively configure their fault count (FC) or other threshold accordingly.

The method for determining the active source to the feeder based on the fault-pulse interval 416 applies only to interrupter/reclosers with pulse-testing capability. That is, there is no equivalent method when the interrupter/reclosers use full reclosing to test for continued fault presence.

The active interrupter/recloser will also apply test voltage pulses to non-faulted phases. The interrupter/recloser will only apply an initial voltage pulse (not an inverse voltage pulse) on non-faulted poles. In particular, a voltage pulse 452 is shown on the voltage trace 450 on non-faulted pole P2, and a voltage pulse 462 is shown on the voltage trace 460 on non-faulted pole P3. These voltage pulses will result in current pulses 422 and 432 on the non-faulted P2 current trace 420 and the non-faulted P3 current trace 430, respectively.

Another method (the third disclosed method) for determining the active source to the feeder is to configure each of the interrupter/reclosers to use a different pole testing interval 464. The pole testing interval 464 is the amount of time between the beginning of the initial voltage pulse 452 on non-faulted pole P2 and the beginning of the initial voltage pulse 462 on non-faulted pole P3, which is detected in each of the sectionalizing switches as the time between current pulses on the two different phases/poles. Of course, the non-faulted phases/poles could be any two—it does not have to be P2 and P3. It is noted that the sectionalizing switches will be equipped with sensors and controls to detect current pulses on the non-faulted poles which will be relatively small, based on loads in the feeder.

The pole testing interval 464 may be pre-configured to have a known and different value for each of the interrupter/reclosers. For example, the interrupter/recloser 302 in the feeder 300 may have the pole testing interval 464 defined as 0.3 seconds, the interrupter/recloser 304 in the feeder 300 may have the pole testing interval 464 defined as 0.6 seconds, and the interrupter/recloser 306 in the feeder 300 may have the pole testing interval 464 defined as 0.9 seconds. The sectionalizing switches in the feeder 300 can then determine which of the interrupter/reclosers is the active source based on the pole testing interval 464, and the sectionalizing switches then adaptively configure their fault count (FC) or other threshold accordingly.

The method for determining the active source to the feeder based on the pole testing interval 464 may also be applied when the interrupter/reclosers use full reclosing to test for continued fault presence. This technique would be applicable where the interrupter/recloser trips open all three phases upon initial fault detection and then recloses the phases one at a time to test for continued fault presence. In this case, the sectionalizing switches measure the time between reclosing on one non-faulted phase and reclosing on another non-faulted phase. Again, based on the determination of the active source, the sectionalizing switches then adaptively configure their fault count (FC) or other threshold accordingly, using preconfigured settings information stored in memory.

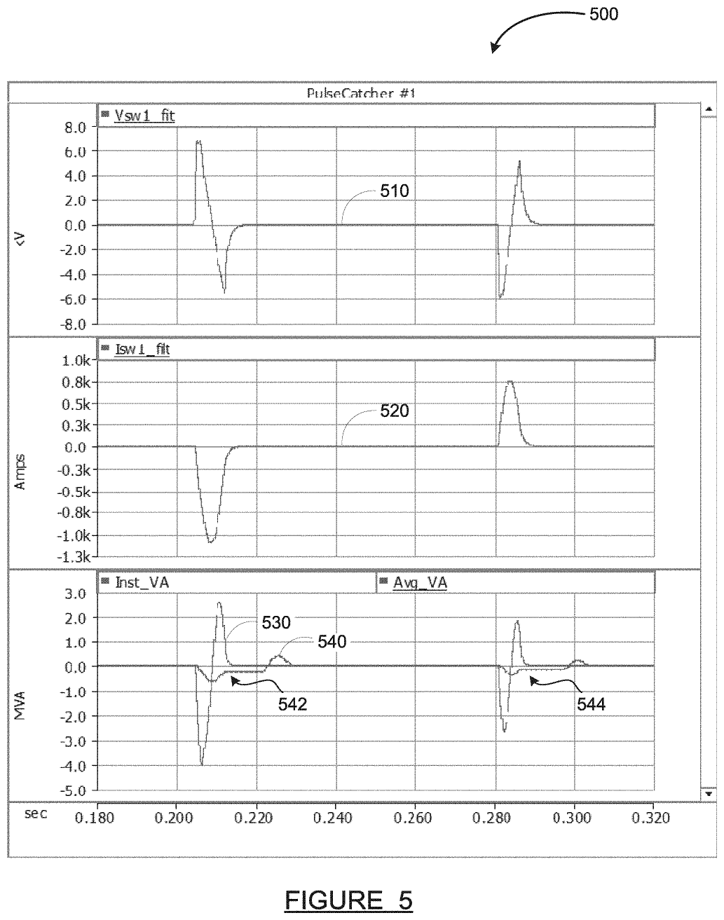

FIG. 5 is a graph 500 of voltage, current and power traces on a faulted phase as measured by a sectionalizing switch, illustrating a fourth method used by sectionalizing switches for determining the active source, according to an embodiment of the present disclosure. The fourth disclosed method for determining the active source to the feeder is to determine the direction of power flow during a test pulse on a faulted phase as measured by sensors and controls at each switch pole. This fourth method requires both voltage and current sensing in the sectionalizing switches. A trace 510 shows the voltage measured at the sectionalizing switch on the faulted phase, where the voltage trace 510 includes pulses which are provided by the test pulses from the active interrupter/recloser. A trace 520 shows the current measured at the sectionalizing switch on the faulted phase, where the current trace 520 includes pulses which are provided by the test pulses from the active interrupter/recloser.

A trace 530 shows the instantaneous total power at the sectionalizing switch on the faulted phase, where the instantaneous power trace 530 is computed from the measured voltage and current values. A trace 540 shows the average power at the sectionalizing switch on the faulted phase, where the average power trace 540 is computed from the measured voltage and current values using a one-cycle sliding window average. The average power trace 540 exhibits a negative average power (cumulative area under the curve) in a region designated by reference numeral 542, and again in a region designated by 544.

Based on a convention for polarity of power flow by direction (from source toward load, or vice versa), the overall negative value of the average power trace 540 can be used to deduce the location of the active source relative to the sectionalizing switch which is measuring the fault voltage and current. For example, if the fault is the fault 320 on the feeder 300 and the sectionalizing switch is the switch 316, the negative cumulative value of the average power trace 540 would indicate that the source is to the right (the interrupter/recloser 304) and the fault is to the left of the switch 316. Based on the knowledge that the source is the interrupter/recloser 304, the switch 316 can establish its fault count threshold as FC=3, and optionally its load count or voltage count threshold as LC=1 or VC=1.

Similar logic can be used by the other sectionalizing switches based on any fault location in the feeder 300. In some cases, it may not be possible to determine which source is active. For example, for the fault 320 and the switch 314, the average power will be overall positive, indicating that the source is to the left of the switch 314. This could be the interrupter/recloser 302 or the interrupter/recloser 304. However, it doesn't matter to the switch 314, as it will set its threshold value to FC=2 either way.

In other cases, there is an ambiguity as to the active source based on power flow direction, and it does affect the FC threshold value. This would be the case if the fault is to the right of the switch 318, for example. The switch 318 would detect an overall positive average power during a test pulse, indicating that the source is to its left and the fault is to its right. The switch 318 would properly set its threshold value to FC=1 for the interrupter/recloser 304, but set its threshold value to FC=2 for the interrupter/recloser 302. In cases such as this, the lower FC threshold value should be chosen. This will cause the switch to open on the first test pulse, when it experiences a fault test pulse waveform. This action will fully isolate the fault, at which point no further switches will open. Because of the potential for ambiguity as to the active source based on power flow direction, this method may be considered to be applicable only to feeders having no more than two available sources.

The method for determining the active source to the feeder based on the direction of power flow during a fault test on a faulted phase may also be applied when the interrupter/reclosers use full reclosing to test for continued fault presence. In this case, the sectionalizing switches measure the voltage and current during a reclosing event rather than a test pulse. The magnitude of the voltage and current measurements will be much higher for a reclosing test than for a test pulse, but the characteristic of average power remains the same and can be used to indicate on which side of the measuring switch the active source is located. This in turn identifies the active source in most cases. Again, based on the determination of the active source, the sectionalizing switches then adaptively configure their fault count (FC) or other threshold accordingly, using preconfigured settings information stored in memory.

All four of the methods discussed above for determining the active source to the feeder are performed after a fault is detected, in the fractions of a second immediately after the active source cuts power to the feeder and then begins its test pulse sequence.

Another method (the fifth disclosed method) for determining the active source to the feeder is to determine the direction of power flow during normal feeder operations before a fault occurs, or during the fault itself. In a manner similar to that discussed above relative to FIG. 5, using their internal current and voltage sensors, the sectionalizing switches can determine whether power is flowing “from left to right” or “from right to left” in FIG. 3 (in other words, determine direction of power flow in the feeder), and from the direction of power flow deduce which is the active source. For example, for the sectionalizing switch 316 of FIG. 3, if power flow is from right to left, then the interrupter/recloser 304 must be the active source (FIG. 3B), and the sectionalizing switch 316 sets its fault count threshold to FC=3. Conversely, if power flow is from left to right, then either the interrupter/recloser 302 (FIG. 3A) or the interrupter/recloser 306 (FIG. 3C) must be the active source, and in either case the sectionalizing switch 316 sets its fault count threshold to FC=1.

The fifth method for determining the active source to the feeder is only applicable for the initially active interrupter/recloser. When other interrupter/reclosers are subsequently activated, the power flow during normal operations is no longer applicable as a technique for determining active source during the FLISR process. It can be used to determine the active source after steady state power flow has been re-established.

The fifth method for determining the active source to the feeder, discussed above, may be used to configure the fault count (FC) threshold settings of the sectionalizing switches during normal feeder operations and/or at the moment of a fault, and the other four methods (or combinations thereof) may be used to determine the active source and adaptively re-configure the threshold (FC, LC and/or VC) settings of the sectionalizing switches during fault isolation when the interrupter/reclosers perform their pulse testing actions. Also, as described above, the open interval method, the pole testing interval method and the power flow direction during testing method may be used to determine the active source when the interrupter/reclosers perform traditional reclosing instead of pulse testing.

In the earlier discussion of FIGS. 2A and 2B, where the switches were configured with pre-defined static logic for opening behavior, it was explained that the sectionalizing switches each included both a threshold for fault count (FC) events and a threshold for voltage count (VC) events. It was explained that a voltage count is a voltage detection (without fault current) event at a switch during a reclosing sequence. The VC threshold is the number of such events that a switch must count during source reclosing attempts for the switch to trigger itself to open. It was also explained that the logic in the sectionalizing switches 212-218 dictates that switches nearest the source recloser have the lowest VC and the highest FC, while switches furthest from the source recloser have the highest VC and the lowest FC. Load count (LC) was also discussed above, where LC thresholds are the same as VC, but counting LC events does not require voltage sensors in the sectionalizing switches.

The discussion of the techniques of the present disclosure, including FIGS. 3-6, described in detail how the sectionalizing switch sequence order, specifically the FC threshold, can be adaptively configured based on the identity of the active source (interrupter/recloser). The same technique also applies to adaptively configuring the VC or LC threshold. That is, when a new interrupter/recloser begins its reclosing sequence, and the switches in the feeder determine the identity of the new active interrupter/recloser, the sectionalizing switches adaptively configure both fault count (FC) and voltage count (VC) or load count (LC) thresholds based on the identity of the new active interrupter/recloser.

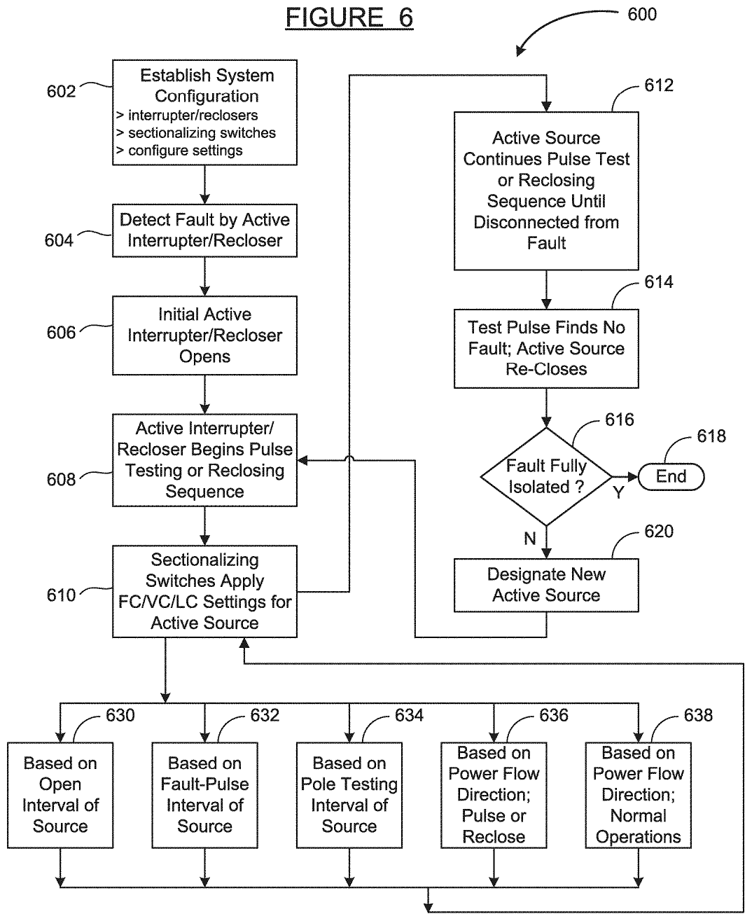

FIG. 6 is a flowchart diagram of a method for defining sectionalizing switch behavior logic to properly isolate a fault based on a determined active feeder source, according to an embodiment of the present disclosure. At box 602, a distribution grid feeder is established, including a plurality of interrupter/reclosers, one at each end of the feeder (two or more ends, depending on branching), and a plurality of sectionalizing switches spaced apart within the interior of the feeder between the interrupter/reclosers. The sectionalizing switches include current sensors for each phase/pole and a controller, and the interrupter/reclosers include the controller, sensors and switches discussed previously. Establishing the feeder at the box 602 includes configuring the settings of each of the sectionalizing switches, such as values of fault count (FC), load count (LC) and voltage count (VC) for the initially active interrupter/recloser and for each other interrupter/recloser which exists at a tie point and may become active for the feeder. Feeder topology information, along with the rules for adaptive configuration of fault count thresholds, are used by the sectionalizing switches to determine the active interrupter/recloser and adapt accordingly.

At box 604, a fault is detected on at least one phase somewhere within the feeder. The fault is detected by the interrupter/recloser which is the active source to the feeder by sensing a high current, a low voltage, or both, on the faulted phase/pole. At box 606, the interrupter/recloser which is the active source opens its switches or contacts to cut power to the feeder. At box 608, the active interrupter/recloser initiates a test pulse sequence or a conventional reclosing sequence designed to determine a presence of the fault and to isolate the fault by triggering sectionalizing switches to open. At box 610, the sectionalizing switches in the feeder adaptively configure their fault count (FC), load count (LC) and voltage count (VC) threshold settings, where configuring the FC, LC and VC threshold settings includes determining which interrupter/recloser is the active source and, based on the pre-defined feeder topology and rules, setting the FC, LC and VC thresholds. The FC threshold is set to a highest value for the sectionalizing switch which is closest to the active source, with sectionalizing switches having an FC threshold value one lower for each switch position further removed from the active source. The VC and LC thresholds are set to a lowest value (1) for the sectionalizing switch which is closest to the active source, with sectionalizing switches having a VC/LC threshold value one higher for each switch position further removed from the active source.

At box 612, the active interrupter/recloser continues its pulse testing or reclosing sequence and the sectionalizing switches open as appropriate based on the configured fault count (FC) threshold, load count (LC) or the voltage count (VC) threshold. The pulse testing or reclosing sequence continues at the box 612 until the opening of a sectionalizing switch causes the active source to be disconnected from the fault (that is, the fault is no longer present to the active interrupter/recloser), or the maximum number of test pulses or recloses is reached. At box 614, after the fault is no longer apparent to the active source, the active source recloses. At decision diamond 616, it is determined if the fault is fully isolated based on which sectionalizing switches have opened. If the fault is fully isolated, the process ends at terminus 618. If the fault is not yet fully isolated, then at box 620 a new active source is selected based on predefined precedence, and the process returns to the box 608 where the new active source initiates its pulse testing or reclosing sequence after a predefined time delay.

Determining the active source at the box 610 may be performed by any of the five methods discussed previously. Specifically, the active source may be determined based on the open interval (OI) of the active interrupter/recloser at box 630, or based on the fault-pulse interval from the active interrupter/recloser at box 632, or based on the pole testing interval from the active interrupter/recloser at box 634, based on power flow direction during pulse testing or reclosing at box 636, or based on power flow direction during normal feeder operations or during a fault at box 638.

As mentioned several times above, the interrupter/reclosers in the feeder 300 may include low energy pulse testing capability, but the pulse testing capability is not required to carry out the sectionalizing switch sequence order configuration of the present disclosure. Thus, a system according to the present disclosure may have interrupter/reclosers which use conventional reclosing techniques, or may have interrupter/reclosers which use pulse testing. The open interval method is applicable to both pulse testing and reclosing sequences by an interrupter/recloser. The fault-pulse interval method is applicable only to pulse testing sequences by an interrupter/recloser. The pole testing interval method is applicable to both pulse testing and reclosing sequences by an interrupter/recloser. The first power flow direction method is applicable to both pulse testing and reclosing sequences by an interrupter/recloser. The second power flow direction method (during normal operations) is applicable to any type of interrupter/recloser because it is based on measurements made before the test sequence. The second power flow direction method (during normal operations) is applicable only to the initially active source interrupter/recloser during the FLISR process, not to subsequent active sources until a steady state power flow has been re-established.

Following the determination of active source using one or more of the methods in the boxes at the bottom of FIG. 6, the process returns to the box 610 for configuring the FC, LC and/or VC threshold settings by the sectionalizing switches.

As will be well understood by those skilled in the art, the several and various steps and processes discussed herein to describe the disclosed methods may be referring to operations performed by a computer, a processor or other electronic calculating device that manipulate and/or transform data using electrical phenomenon. In particular, this refers to the control calculations and operations performed by controllers or processors included in each of the sectionalizing switches in the feeder of FIG. 3, and also the controller or processor included in the interrupter/reclosers of FIG. 3. Those processors and electronic devices may employ various volatile and/or non-volatile memories including non-transitory computer-readable medium with an executable program stored thereon including various code or executable instructions able to be performed by the computer or processor, where the memory and/or computer-readable medium may include all forms and types of memory and other computer-readable media.

The disclosed methods for fault location, isolation and service restoration—by adaptively configuring sectionalizing switch sequence (fault count and voltage count thresholds) based on the active source—provide a means for implementing FLISR without a separate communications system infrastructure and communications equipment at each switching device. Using these methods, FLISR implementations become less expensive and are not susceptible to communication system outages, which provides significant benefit to electrical power distribution companies, and to all consumers on the grid.

The foregoing discussion discloses and describes merely exemplary embodiments of the present disclosure. One skilled in the art will readily recognize from such discussion and from the accompanying drawings and claims that various changes, modifications and variations can be made therein without departing from the spirit and scope of the disclosure as defined in the following claims.

What is claimed is:

1. A method for locating and isolating faults in a distribution grid feeder, the feeder including a plurality of sectionalizing switches and a plurality of interrupter/reclosers, the method comprising:
providing, to each switch in the feeder, rules for establishing a fault count threshold based on which of the interrupter/reclosers is active;
detecting a fault in the feeder by the active interrupter/recloser;
opening contacts in the active interrupter/recloser to cut off power to the feeder;
initiating a test pulse sequence or a reclosing sequence by the active interrupter/recloser;
determining which interrupter/recloser is active and adaptively setting the fault count threshold based on the rules, by each switch in the feeder; and
continuing the test pulse sequence or the reclosing sequence by the active interrupter/recloser, with each switch opening if it reaches its fault count threshold, until a maximum number of test pulses or reclosing attempts is reached.

2. The method according to claim 1 wherein each of the sectionalizing switches includes current sensors and a controller having a processor and memory, the controller receiving signals from the current sensors and being configured to adaptively set the fault count threshold and open the switch when the fault count threshold for the switch is reached.

3. The method according to claim 1 wherein each of the interrupter/reclosers includes voltage and current sensors and a controller having a processor and memory, the controller receiving signals from the sensors and being configured to open and close the contacts in the interrupter/recloser and control the test pulse sequence or the reclosing sequence.

4. The method according to claim 1 wherein adaptively setting the fault count threshold based on the rules by each switch includes setting the fault count threshold for a switch furthest removed from the active interrupter/recloser to one, and setting the fault count threshold for each other switch to a value one higher for each position the switch is nearer the active interrupter/recloser.

5. The method according to claim 1 wherein the test pulse sequence includes a sequence of low energy pulses provided by the active interrupter/recloser at timed intervals, where the pulses are configured to allow each of the sectionalizing switches to determine if it is located between the active interrupter/recloser and the fault.

6. The method according to claim 1 wherein the reclosing sequence includes a sequence of full-voltage reclosing attempts by the active interrupter/recloser at timed intervals, where the reclosing attempts are configured to allow each of the sectionalizing switches to determine if it is located between the active interrupter/recloser and the fault.

7. The method according to claim 1 wherein determining which interrupter/recloser is active includes detecting an open interval, where the open interval is an elapsed time from when the active interrupter/recloser cut off power to the feeder until a first test pulse is sent or a first reclosing is attempted, and where each of the interrupter/reclosers in the feeder uses a unique value of the open interval.

8. The method according to claim 1 wherein determining which interrupter/recloser is active includes detecting a fault-pulse interval, where the fault-pulse interval is an elapsed time between initial and inverse pulses as measured on a pole connected to a faulted phase, and where each of the interrupter/reclosers in the feeder uses a unique value of the fault-pulse interval.

9. The method according to claim 1 wherein determining which interrupter/recloser is active includes detecting a pole testing interval, where the pole testing interval is an elapsed time between test pulses or reclosing attempts on different non-faulted poles, and where each of the interrupter/reclosers in the feeder uses a unique value of the pole testing interval.

10. The method according to claim 1 wherein determining which interrupter/recloser is active includes detecting a power flow direction on a faulted pole during test pulses or reclosing attempts, where the sectionalizing switches further include voltage sensors, and the power flow direction is determined from an average power computed over a one-cycle or other sliding time window.

11. The method according to claim 1 wherein determining which interrupter/recloser is active includes detecting a power flow direction during normal feeder operations or during a fault event, where the sectionalizing switches further include voltage sensors, and the power flow direction is determined from an average power computed over a sliding time window.

12. The method according to claim 1 further comprising, when the active interrupter/recloser determines that it is disconnected from the fault, reclosing the contacts in the active interrupter/recloser.

13. The method according to claim 12 further comprising, when the fault is not fully isolated, designating a new active interrupter/recloser to initiate its test pulse sequence or reclosing sequence.

14. The method according to claim 1 further comprising providing rules for establish a voltage count threshold, adaptively setting the voltage count threshold based on the rules by each switch, and opening each switch during the test pulse sequence or the reclosing sequence if the switch reaches its voltage count threshold, where the voltage count threshold is lowest for a switch nearest the active interrupter/recloser.

15. The method according to claim 1 further comprising providing rules for establish a load count threshold, adaptively setting the load count threshold based on the rules by each switch, and opening each switch during the test pulse sequence or the reclosing sequence if the switch reaches its load count threshold, where the load count threshold is lowest for a switch nearest the active interrupter/recloser.

16. A fault location, isolation and service restoration system for a distribution grid feeder, the system comprising:
a plurality of interrupter/reclosers each including voltage and current sensors and a controller having a processor and memory, the controller receiving signals from the sensors and being configured to open and close contacts in the interrupter/recloser and control a test pulse sequence or a reclosing sequence, where one interrupter/recloser is located at each branch end of the feeder;
a plurality of sectionalizing switches spaced apart throughout the feeder, where each of the sectionalizing switches includes voltage and current sensors and a controller having a processor and memory, the controller receiving signals from the sensors and being configured to open the switch when a fault count threshold, a load count threshold or a voltage count threshold for the switch is reached during the test pulse or reclosing sequence, and where the controller is pre-configured with rules for adaptively setting the thresholds,
where an active interrupter/recloser, when a fault is detected in the feeder, opens the contacts to cut off power to the feeder and initiates the test pulse sequence or the reclosing sequence,
and where each sectionalizing switch, when power is cut off in response to the fault, determines which interrupter/recloser is active and adaptively sets the fault count threshold, the load count threshold and the voltage count threshold based on the active interrupter/recloser.

17. The system according to claim 16 wherein the active interrupter/recloser continues the test pulse sequence or the reclosing sequence, with each sectionalizing switch opening if it reaches its fault count threshold, its load count threshold or its voltage count threshold, until a maximum number of test pulses or reclosing attempts is reached.

18. The system according to claim 17 wherein, when the active interrupter/recloser determines that it is disconnected from the fault by one or more open sectionalizing switch, the active interrupter/recloser re-closes the contacts and a new active interrupter/recloser is designated to initiate its test pulse sequence or reclosing sequence.

19. The system according to claim 16 wherein the rules for adaptively setting the thresholds include setting the load count threshold and the voltage count threshold for a switch nearest the active interrupter/recloser to one, and setting the load count threshold and voltage count threshold for each other switch to a value one higher for each position the switch is further removed from the active interrupter/recloser.

20. The system according to claim 16 wherein the rules for adaptively setting the thresholds include setting the fault count threshold for a switch furthest removed from the active interrupter/recloser to one, and setting the fault count threshold for each other switch to a value one higher for each position the switch is nearer the active interrupter/recloser, where the fault count threshold defines a number of fault pulse events or fault current events at which the switch will open.

21. The system according to claim 16 wherein the active interrupter/recloser is determined by the sectionalizing switches by evaluating timing of pulse events or reclosing attempts from the active interrupter/recloser, where each of the interrupter/reclosers in the feeder uses a unique value of the timing of the pulse events or the reclosing attempts.

22. The system according to claim 16 wherein the active interrupter/recloser is determined by the sectionalizing switches by detecting a power flow direction during normal feeder operation, during a fault or during test pulses, where the power flow direction is determined from an average power computed over a sliding window.
